(19) United States
(12) Patent Application Publication
(10) Pub. No.: US 2009/0208698 A1
(43) Pub. Date: Aug. 20, 2009

(54) Medical Planar Structure

(75) Inventor: Guenter Langen, Wolfstein (DE)

Correspondence Address: DREISS, FUHLENDORF, STEIMLE & BECKER, POSTFACH 10 37 62, D-70032 STUTTGART, DE

(73) Assignee: KARL OTTO BRAUN GMBH & CO. KG, Wolfstein (DE)

(21) Appl. No.: 12/227,018

(22) PCT Filed: Apr. 27, 2007
(86) PCT No.: PCT/EP2007/003716

§ 371 Date: Nov. 5, 2008

(30) Foreign Application Priority Data
May 11, 2006 (DE) 10 2006 022 971.1

(51) Int. Cl. B32B 3/06; B32B 7/04; B29C 65/00

(52) U.S. Cl. 428/100; 156/91; 156/297; 156/244.22

(57) ABSTRACT

The invention relates to a medical adhesive planar structure which is designed to be elastically extensible and has an extensibility of between 40% and 300%, comprising a textile substrate, wherein the substrate has a first side and a second side and comprises at least one warp thread group, wherein a first mechanical adhesive structure is applied to the first side of the substrate and is composed of a multiplicity of discrete first adhesive elements, and the first mechanical adhesive structure can be brought into adhesive connection with a second mechanical adhesive structure on the second side of the substrate opposite the first side.

The invention relates to a medical adhesive planar structure, preferably in the form of bandage, that is elastically extensible and has an extensibility of between 40 and 300%, comprising a textile substrate, wherein the substrate has a first side and a second side and comprises at least one warp thread group.

In prior art, the use of extensible or elastic medical planar structures in the form of wovens, knitted fabrics, and nonwovens is known, wherein elastic warp threads are made of high-twist cotton yarn, elastodiene fiber, spandex, thermoplastic rubber or textured multifilament yarn made of chemical fibers partly combined with other non-elastic warp threads and suitable weft threads and nonwovens. The planar structure manufactured in this way exhibits elastic extensibility parallel to the warp threads, i.e. the planar structure can be stretched by applying a tensile force in the longitudinal direction and returns by elastic recovery to its original non-stretched condition more or less immediately after removal of the tensile force. To achieve better fastening of such elastic bandages on the part of the body, prior art provides the possibility of a pressure-sensitive bonding coating of the textile surface using bonding agents with cohesive or adhesive properties. Such medical planar structures have the ability to adhere to themselves, i.e. when a bandage is wound on and pressed, the bandage layers adhere to each other (contact adhesion), providing a non-slip bandage.

If cohesive bonding agents are used, the bandage layers only adhere to themselves and not to other surfaces, such as skin, hair, or clothing. Adhesive bonding agents, by contrast, also adhere to other surfaces, in particular, skin. In the case of cohesive bandages, natural rubber latex is used as the cohesive bonding agent, which has the disadvantage that it can cause allergies.

Thus elastic bandages with a pressure-sensitive bonding coating are known, for example, from EP 0 258 484 and WO 00/68334 Al, in which numerous examples of cohesive and adhesive bonding agents are mentioned. These also describe the disadvantages of known cohesive bandages based on natural rubber latex, i.e. lack of resistance to light, temperature, and aging and the presence of potentially allergenic proteins and peptides that can result in contact allergies of type I in some users and patients. This problem is to be countered by the use of a bonding agent based on hot-melt glue in the form of a natural-latex-free rubber-resin mixture with defined rheological properties.

However, the disadvantages of this include both the complicated processing and coating and residual stickiness on the skin due to resin additives, i.e. the at least partially adhesive nature of the bonding. Moreover, the application of high-viscosity hot-melt glue adversely affects the elastic deformability or maximum extensibility of the substrate textile.

WO 2004/058122 describes a medical bandage with a depot function for administering active substances to the skin or part of the body. The bandage consists of a flexible substrate in the form of a tape that is fitted with a few strip-like adhesive foil tapes that extend over the entire length and/or width of the substrate. The adhesive strips are fixed to the reverse side of the substrate, adversely affecting the flexibility of the substrate. The adhesive strips are preferably attached near to the ends of the strip-like substrate to ensure even adhesion over the entire surface of the substrate.

DE 198 54 320 describes a textile planar structure with an adhesive surface that is formed by inclusion of tape-shaped hook-and-loop fastener threads by a weaving or knitting process directly as part of manufacturing the textile planar structure. The hook-and-loop fastener threads extend over the entire length of the planar structure, impeding the elastically extensible properties of the substrate.

EP 950 363 describes a process for manufacturing cast planar hook-and-loop fasteners in the shape of polymer foils, on the surface of which means of adhesion are attached in the shape of stems and hooks. The stems can have heads with various shapes, e.g. a mushroom head, to permit better catching in the mating part of the planar hook-and-loop fastener (furred side). The stems and hooks can be disposed on the surface of the polymer foils with different geometries.

EP 723 406 and WO 99/17631 describe elastic fastening systems in which the hooks or stems are attached to an elastically extensible substrate made of natural rubber, thermoplastic rubber, polyurethane elastomers, or metallocene-catalyzed polyolefins. The substrate in the form of foils or foams can exhibit extensibility of up to 100% and is laminated with the foil comprising the fastening hooks. Such elastic planar fasteners are advantageously deployed for fastening elastic diapers or other hygiene products.

Extensibility of 40% to 300% is a normal value for elastic bandages for medical applications such as support, relief, or compression of parts of the body, a distinction being made between bandages with short, medium, and long-stretch properties depending on the maximum extensibility. The extensibility is determined in accordance with DIN 61632-1985, the maximum extensibility comprising an elastic and a non-elastic component. Hereinafter the two aspects are combined in the term “elastically extensible,” which covers both purely extensible and purely elastic properties and all transitional graduations between these properties.

The object of the invention is to provide an elastically extensible medical planar structure with adhesive properties, wherein the planar structure does not adhere either to skin or hair, the potential risk of producing allergies is prevented, and at the same time the physical properties, such as the elastically extensible property, of the textile substrate are adversely affected to the smallest possible extent.

The invention achieves this object with a medical planar structure of the kind mentioned above, wherein a first mechanical adhesive structure is applied to the first side of the substrate and is composed of a multiplicity of discrete first adhesive elements, and the first mechanical adhesive structure can be brought into adhesive connection with a second mechanical adhesive structure on the second side of the substrate opposite the first side.

Mechanical adhesive structure refers to a structure in which adhesion is not achieved using bonding agents with adhesive or cohesive properties but by means of a mechanical hook or the inter-gripping of two adhesive elements.

The medical planar structure, which has a length L and a width B, is preferably homogeneously elastically extensible over the entire length L. A homogeneous elastically extensible planar structure of length L and a width B is a planar structure that has extensibility Dₜₒₜ. of X % where 40%<X %<300% over its length L and at the same time the extensibility D_{subreg} of each subregion of the planar structures with the length 0.1 L has approximately the same discrete value between 40% and 300%, wherein the values Dₜₒₜ. and D_{subreg} deviate from each other in total by no more than 15% and the subregion 0.1 L must not be longer than 20 cm. The extensibility is determined according to DIN 61632-1985, with the maximum extensibility comprising an elastic and a non-elastic component.

In particular, an inventive medical planar structure has extensibility Dₜₒₜ of 40 to 200%. It is highly preferred that this planar structure has extensibility Dₜₒₜ of 60 to 200% and, in particular, 60 to 160%. It is also possible, however, for the planar structure to have an extensibility of 40 to 120% or 120 to 200%, wherein especially preferably all of these planar structures are homogeneously elastically extensible.

In a further especially preferred embodiment, the medical planar structure has a length L and a width B and an extensibility of 60 to 160%, wherein the planar structure is homogeneously elastically extensible over the entire length L.

Moreover, the adhesion of the surfaces of the inventive medical planar structure (measured as adhesive force in cN/cm) at each point of the medical planar structure is preferably equal on average, i.e. the adhesive force per centimeter of width of the planar structure over the length of the planar structure is constant within the limits of variation of ±15%. The adhesive force is determined by the method of DIN EN 12242-1999 “Touch and close fasteners—Determination of peel strength,” wherein a metal cylindrical weight of 10 kg is always used for overrolling and pressing the adhesive textile surfaces for a sample width greater than 5 cm. The two legs of a measurement sample prepared in this way are separated in a tensile test machine at a constant test speed and the necessary force is measured over a defined separation distance. The adhesive force results from the arithmetic mean of the separating force with reference to a one-cm sample width.

This solves the technical problem of providing an elastically extensible base textile with an adhesive surface without significantly changing the physical properties of the textile substrate, such as weight per unit area, extensibility, flexibility, permeability to air, wearing comfort, etc. without achieving adhesion by means of pressure-sensitive bonding agents with adhesive or cohesive properties, but by instead using mechanical hooking or inter-gripping between two adhesive elements with different geometries.

The adhesive action is not based on the use of a bonding agent with a cohesive or adhesive bonding action, such as polymer products based on natural rubber, polyacrylate or other pressure-sensitive bonding agents, which have allergenic or skin-irritating potential. The inventive planar structure exhibits improved skin compatibility as compared with known cohesive bandages based on natural rubber latex. At the same time, the inventive planar structure preferably does not, however, adhere to the skin and hair, as a pressure-sensitive adhesive plaster does and is therefore easy to apply and wear, for example, in the form of a bandage.

It is possible for the first discrete adhesive elements to interact with further adhesive elements on the second side, which are also disposed on the substrate, or alternately the substrate material itself can also act as an adhesive structure on the second side. The adhesive elements on the second side can consist of individual threads or fibers of the textile substrate, wherein the individual threads or fibers are also means of adhesion. In particular, the multiplicity of first adhesive elements is disposed exclusively on the first side of the planar structure. However, it is possible for a further multiplicity of first adhesive elements to be additionally attached to the second side of the planar structure. This is possible as an alternative or in addition to provision of the substrate surface as an adhesive structure.

In an especially preferred embodiment, the first discrete adhesive elements can have a density per unit area of 10² to 10⁶ per square meter on the substrate in the non-stretched condition of the planar structure. Planar geometric bodies of defined length L, width B, and height H can be used as first adhesive elements, wherein means of adhesion are provided on at least one first surface of the adhesive elements. The ratio of the height H to the length of this planar geometric body is in the range 1 to 10⁻³. Such adhesive elements can be disposed in a regular or irregular discrete distribution over the entire surface of the textile substrate, in patterns, but also in groups, clusters, etc.

The horizontal geometry (parallel to the first or second side of the textile substrate) of the planar geometric bodies can preferably have a strip-like, square, round, semi-circular, elliptical, cross-shaped, or star-shaped base surface of defined length and width and linear vertical geometry of height H (perpendicular to the first or second side of the textile substrate). The base surface can also have a triangular, rectangular, pentagonal, hexagonal, or other polygonal shape, and edges and angles may be regular or irregular. The means of adhesion can only be attached to one surface of the planar geometric body, but these can also be attached to multiple surfaces (front, rear, ends) oriented in multiple directions.

For example, it is possible to dispose cut pieces of a polymer foil on which the means of adhesion are provided as adhesive elements on the textile substrate, with the possibility of thus achieving a defined distribution and density per unit area. The density per unit area of the adhesive elements can be in a range of 10² to 10⁶ items per m²—relative to the non-stretched condition of the planar structure (determined according to EN 1773-1996). The means of adhesion can be oriented on one or more surfaces (front, rear, or end) of the cut pieces of the polymer foil. In particular, the first adhesive elements can have a base surface A with length L and a width B, means of adhesion being attached to the first side and to the second side of the adhesive elements. These means of adhesion may be hooks, stems, mushroom heads, palm branch, or lamella that enter into a connection with the second and the first side of the textile substrate by hooking and therefore provide reversible adhesion.

So-called adhesive particles can also be used as the adhesive elements, whose preferred height-to-length ratio is approximately 1 to 10⁻¹. Particle geometric bodies with spherical, ellipsoidal, pyramidal, or cuboid shapes are used. The surfaces of these adhesive particles can be occupied on all sides by means of adhesion. The orientation of the linear axis of the means of adhesion is then preferably radial, i.e. toward the center of gravity of the adhesive particle.

The adhesive elements can be disposed on one or both sides of the substrate.

The means of adhesion disposed on the surface of the adhesive elements have a defined shape that is chosen to achieve adhesive attachment of the adhesive elements to the second side of the planar structure or with a multiplicity of second adhesive elements. The means of adhesion are preferably shaped like stems with or without heads or like hooks. Examples of these are found in the documents cited above. The “stem” shape is represented, for example, by cylindrical, cuboid, or pyramidal, needle-like geometric bodies, whose longitudinal axis forms a defined angle with the surface of the adhesive elements. The stems can also be oriented at various angles, e.g. diagonally opposite, i.e. alternating one row at an angle of 70° with respect to the surface of the adhesive elements, on which the means of adhesion are defined, with a second row at an angle of 110° with respect to that surface. The stems can have a head part at the end that supports easier inter-gripping of the means of adhesion and their attachment, in particular to the reverse side of the substrate. Single and multiple heads with various shapes, such as disks, mushroom heads, flat plates can be used, and the shape of their edges may be smooth, lobed, or toothed.

The “hook” shape is represented by curved geometric bodies in the shape of a hook with a curved tip that are positioned on the surface of the adhesive elements analogously to the geometries, angles, and configurations of the described stem shapes.

The means of adhesion preferably consist of the same material as the adhesive elements.

For the invention, adhesive elements are preferably used in which the means of adhesion are disposed on the surface in a density per unit area of 100 to 5000 items per cm².

If the adhesive elements are cut pieces of a polymer foil, rigid foils made of standard plastics such as polyamide (PA), polyester (PES), polypropylene (PP), and polyethylene (PE) or also soft and flexible polymer foils made of plastics with a certain elastic extensibility such as metallocene-catalyzed polyolefin such as polyethylene (PE) or polypropylene (PP), thermoplastic polyurethanes (TPU) or thermoplastic rubbers (TR) can be used. However, flexible foils are preferred because they adversely affect the elastic deformability of the substrate to a lesser degree.

It is possible for the adhesive elements to have various geometric shapes. Different densities per unit area of the adhesive elements over the planar structure are also possible.

In particular, flat, strip-like, or grid-shaped cut pieces of such polymer foils that form the adhesive element and bear the means of adhesion can be used. It is also possible for the adhesive elements to be constituted as planar elements in which the means of adhesion are disposed on one or both surfaces of the textile substrate. The shape of the planar shaped cut pieces can be round, oval, square, rectangular, polygonal, star-shaped, or mixed shapes combining these basic forms.

The adhesive elements in the form of cut foil pieces can be fixed on the surface of the substrate by suitable connection techniques, such as sewing or bonding or welding or pressing. Sewing means fixture of the adhesive elements using suitable sewing threads and needles that penetrate the substrate and the adhesive elements, wherein the connection is established by means of the sewing threads. Bonding means fixture of the adhesive elements using suitable bonding agents in solid, liquid, or paste form. The bonding agents can be water-based or solvent-based, or thermoplastic hot-melt glues can be used in the molten condition by applying the glues by spraying, spreading, doctoring, slop-padding, rolling, embossing, screen-printing systems, or nozzle application systems onto the smooth reverse side of the adhesive elements or the substrate surface to fix the adhesive elements on the substrate. Thermoplastic hot-melt glues can, for example, be used in the cold condition as adhesive films, adhesive fibers, adhesive powder, adhesive nonwovens or adhesive nets that are applied to the reverse side of the adhesive elements and are brought into an adhesive bond with the surface of the substrate after heating in the hot, adhesive condition. Welding means direct connection of the adhesive elements with the substrate by spot or full-surface heating of the adhesive elements with a hot-air or hot-gas flow or an open flame (flame lamination method) or with heated dies, rollers, calenders or embossing cylinders or ultrasound sonotrodes. The connection is achieved by softening or melting the thermoplastic polymer foil. All suitable technical equipment and methods for hot welding, ultrasound welding, or high-frequency welding can be used, as long as the means of adhesion are only insignificantly destroyed by the welding process. Pressing means that the adhesive elements are directly fixed on the surface of the substrate by attaching the means of adhesion to the surface of the substrate by the application of pressure. The configuration may be statistical, disordered, geometrically evenly distributed, or clustered.

In this case, it is essential that the extensibility of the planar structure be 40 to 300% and the elastically extensible deformability of the textile substrate be restricted as little as possible.

The advantage of using the particle-like structures described above, on which the means of adhesion are provided, is that this adversely affects the elasticity as little as possible.

The proportion that the adhesive structure makes up of the one-sided surface of the base textile or the textile substrate is in the range 1 to 50%, preferably 1 to 30% and especially preferably 5 to 20% of the one-sided area of the substrate. This refers to the surface in the non-stretched condition of the textile, the non-stretched surface being determined by simple multiplication of the length and width determined according to EN 1773.

The geometric shape, the height and the density per unit area of the means of adhesion and the structure of the textile substrate determine the magnitude of the adhesive force acting between the individual layers of the substrate. Depending on the material structure, density, elasticity and weight per unit area of the basic textile, the adhesive force is in the range between 5 and 150 cN/cm. In the case of light base textiles for fixation bandages (up to 50 g/m² in the stretched condition), an adhesive force of 5 to 50 cN/cm is already enough for ensure layer adhesion. In the case of a base textile, for example, for supporting and compression bandages (with 50 to 200 g/m² in the stretched condition), higher adhesive forces of 50 to 150 cN/cm are necessary.

If foils disposed on the substrate are used as the adhesive element to form the adhesive structure, a base thickness of 50 to 200 μm is preferred. The means of adhesion disposed on these have a height of 100 to 400 μm. The density per unit area of the means of adhesion is preferably between 100 and 5000 items per square centimeter.

In an especially preferred embodiment, the first discrete adhesive elements can have a density per unit area of 10² to 10⁶ per square meter on the substrate in the non-stretched condition of the planar structure, the adhesive force being 50 to 150 cN/cm. In a highly preferred embodiment, the first discrete adhesive elements can have a density per unit area of 10² to 10⁶ per square meter on the substrate in the non-stretched condition of the planar structure. In this case, the proportion that the adhesive structure makes up of the one-sided surface of the base textile or the textile substrate is in the range 1 to 50% and the adhesive force is 50 to 150 cN/cm.

Moreover, it is also possible for the textile substrate to have at least one warp thread group that consists of elastically extensible textile threads, for example, made of high-twist cotton thread, elastodiene, spandex, thermoplastic rubber, or textured multifilament yarns made of chemical fibers. Such elastically extensible warp threads can in some cases also be processed in conjunction with other non-elastic or rigid warp threads or suitable weft threads or nonwovens.

Medical planar structures are preferred that comprise a textile substrate that comprises a first and at least one second warp thread group. Medical planar structures are especially preferred that comprise a textile substrate that comprises a first and at least one second warp thread group, wherein the first warp thread group consists of elastic threads and the at least one second warp thread group consists of non-elastic threads.

Moreover, the medical planar structures can comprise a substrate that also comprises one or more weft threads. In particular, the medical planar structure can comprise a substrate that comprises a first and a second warp thread group and a weft thread. In this case, the first warp thread group is elastically extensible while the second warp thread group and the weft thread consist of non-elastic threads.

However, it is also possible for the textile substrate to comprise a nonwoven. Medical planar structures are highly preferred that comprise a textile substrate that is a woven, knitted fabric, stitch-bonded nonwoven or stitch-bonded knitted. If the textile substrate is a stitch-bonded knitted, in particular, a Malimo stitch-bonded knitted, it is possible for this knitted fabric to be additionally reinforced by a nonwoven in the form of a spunbonded nonwoven or a staple fiber nonwoven. In particular, such medical planar structures with a woven, knitted fabric, stitch-bonded nonwoven or stitch-bonded knitted as a textile substrate have a weight per unit area of at least 10 g/m² and no more than 350 g/m², and especially preferably a weight per unit area of at least 20 g/m² and no more than 60 g/m² or at least 70 g/m² and no more than 350 g/m².

The adhesive force between the layers of the inventive medical planar structure is determined as the peel strength of the planar structure according to DIN EN 12242 and is at least 5 cN/cm to ensure sufficient adhesion between layers. In particular, the medical planar structure is to have an adhesive force of 5-120 cN/cm and an adhesive force of 20-120 cN/cm is highly preferred.

Such medical planar structures can, in particular, be used as elastic bandages for fixation, supporting, relief, and compression applications on the human or animal body.

With such a planar structure, an elastic bandage material or an elastic bandage can be implemented with an adhesive surface without the need to use bonding agents of a cohesive or adhesive nature on the surface. The adhesive effect is achieved purely mechanically by means of inter-gripping of the adhesive structures and/or means of adhesion in conjunction with the textile substrate. The connections that result from the inter-gripping of the means of adhesion can be separated again without any significant damage to the textile substrate. Moreover, in the manner described above, adhesive bandages are provided that exhibit improved aging, storage, and light resistance because the means of adhesion used, preferably polymer foils with means of adhesion disposed upon them, exhibit better aging, storage, and light stability than the known cohesive or adhesive bonding agents. An additional advantage is that further non-adhesive textile products may adhere to an inventive planar structure secured on the part of the body and bearing the adhesive elements on the outside (the side facing away from the body). Such further non-adhesive textile products include additional bandages, pads, compresses, accessories, etc., if these enter into a connection with the adhesive elements. This is an advantage, for example, for multi-layer bandages that are preferably used in compression therapy to treat disorders of the leg veins. In this case, a first bandage is wound directly onto the lower leg and then one, two, or three further bandages of differing quality that do not adhere or bond to each other are wound in layers one on top of the other. The resulting, multi-layered compression bandage is then usually intended to be worn permanently by the patient for a period of several weeks. An inventive adhesive bandage as described above adds an internal adhesive bond with the next layer of the bandage to this multi-layered bandage which has the advantages of being resistant to slipping and ensuring secure positioning of the individual layers of the bandage, one on top of the other.

In the inventive planar structures, the extensibility was determined according to DIN 61632, as was the recovery capability. DIN 53887 was used to determine the permeability to air.

Various adhesive elements and a planar structure are explained below by means of a drawing for greater clarity. The figures show:

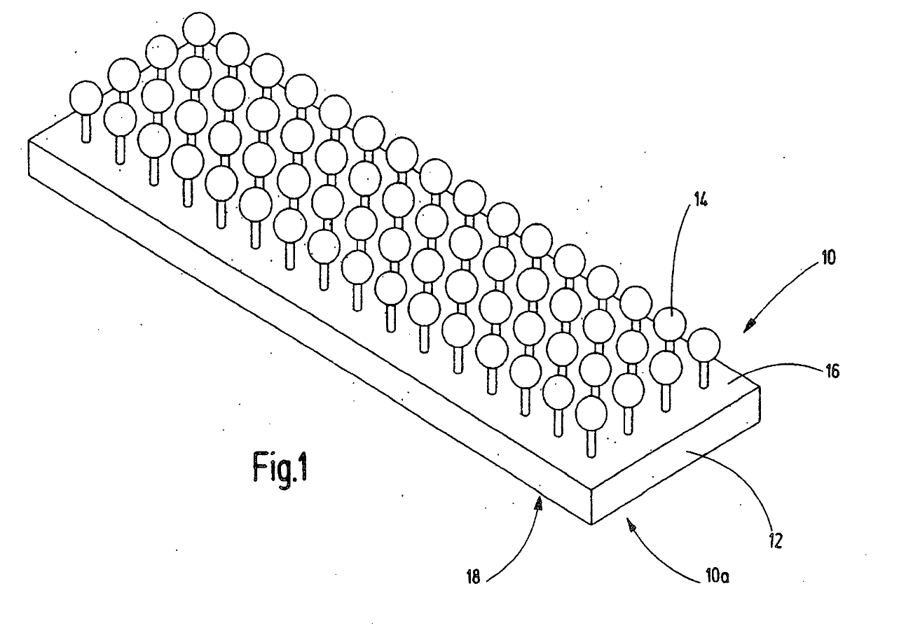

FIGS. 1-5: various embodiments of the adhesive elements and

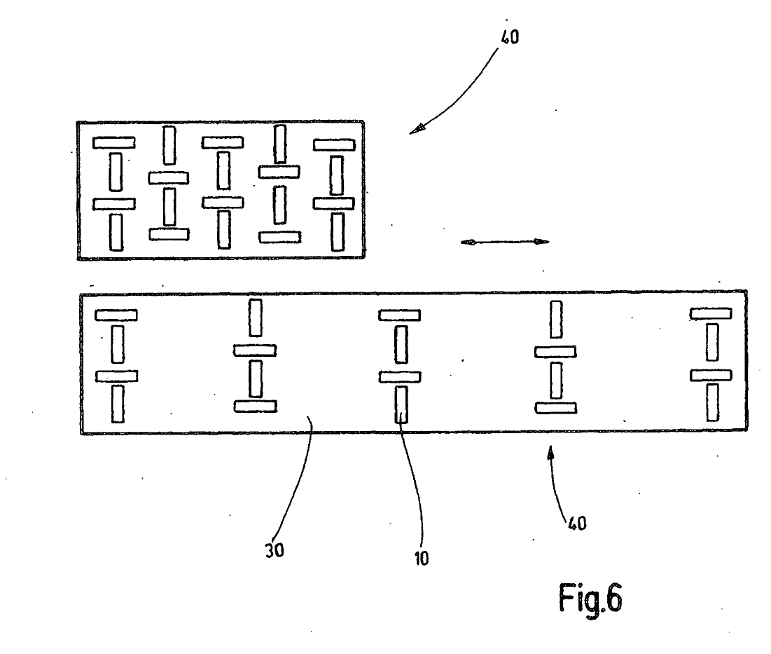

FIG. 6: a top view of part of an inventive planar structure.

FIG. 1 shows a first adhesive element 10a, constituted as a planar geometric body 10, on which means of adhesion 14 with the shape of stems with mushroom heads are provided on a polymer foil 12 with a thickness of 100 μm, wherein the mushroom heads are constituted as spherical knobs. The means of adhesion 14 are applied only to one side 16 of the foil. The foil is then attached to a textile substrate (not shown) at the second side 18 to form an inventive planar structure 40 (FIG. 6). This can be done by a welding method. Such adhesive elements 10a can be provided on one or both sides of the substrate.

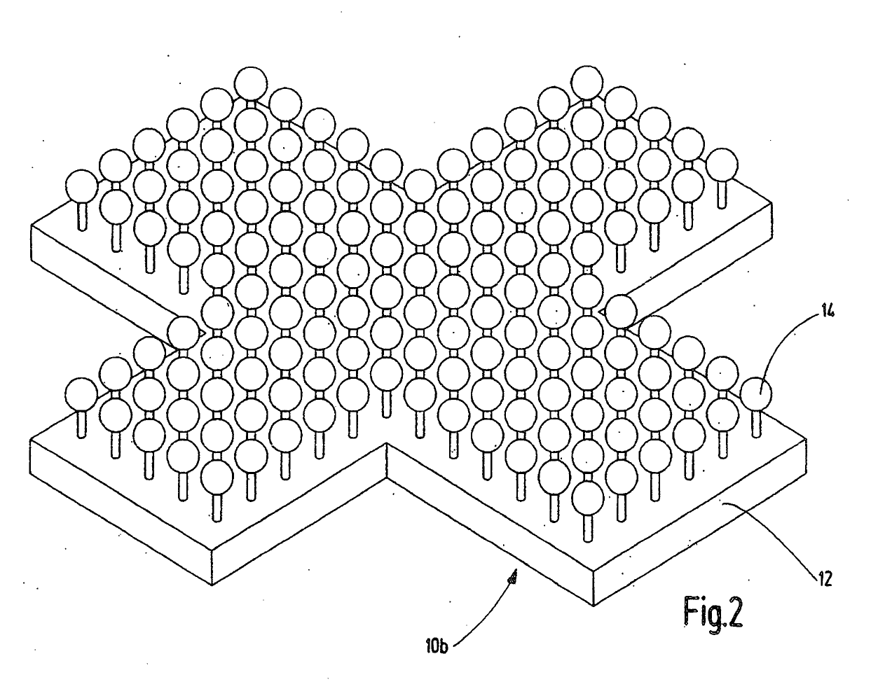

FIG. 2 shows an analogous embodiment of an adhesive element 10b, wherein the base surface of the polymer foil is not rectangular as in FIG. 1 but a cross-shaped base surface is provided. The means of adhesion 14 are provided and arranged is as in FIG. 1.

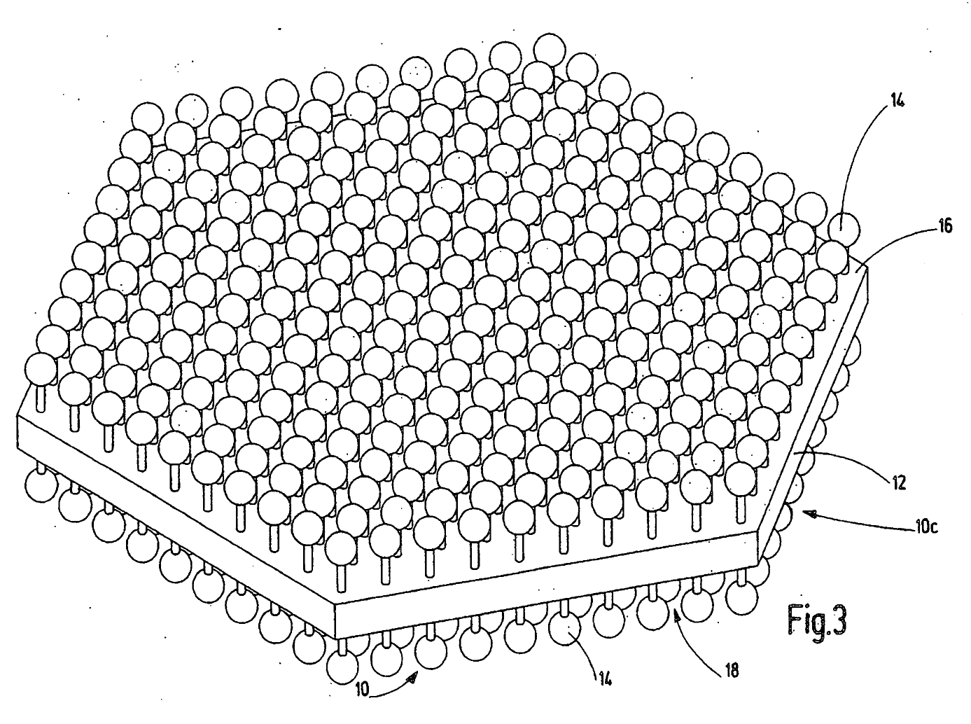

FIG. 3 shows an adhesive element 10c in the shape of a planar geometric body 10 with a polygonal, viz. hexagonal base surface. Unlike in the examples given above, the means of adhesion 14 are disposed on both surfaces 16, 18 of the polymer foil 12. In this case, the means of adhesion 14 on one side 16 are for connecting with the first side of a textile substrate, i.e. the adhesive elements 10c are attached to the substrate by means of the means of adhesion 14 and the means of adhesion 14 on the other side 18 are used to connect the first side of the substrate with an adhesive structure on the second side of the substrate.

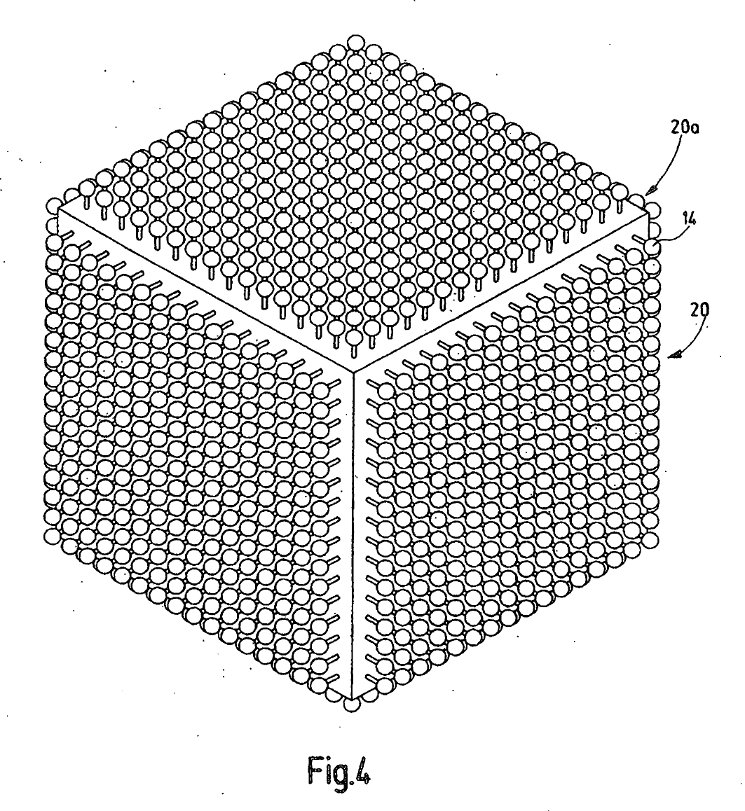

FIG. 4 shows a so-called adhesive particle 20a that is constituted by a three-dimensional geometric body 20 and that has cube-shaped geometry. The particle 20a bears means of adhesion 14 that are the same as those described above. The means of adhesion 14 are disposed on all sides and are used both for the connection of a first side of the substrate or planar structure with a second side of the substrate or planar structure and for attaching the adhesive particle 20a to the substrate.

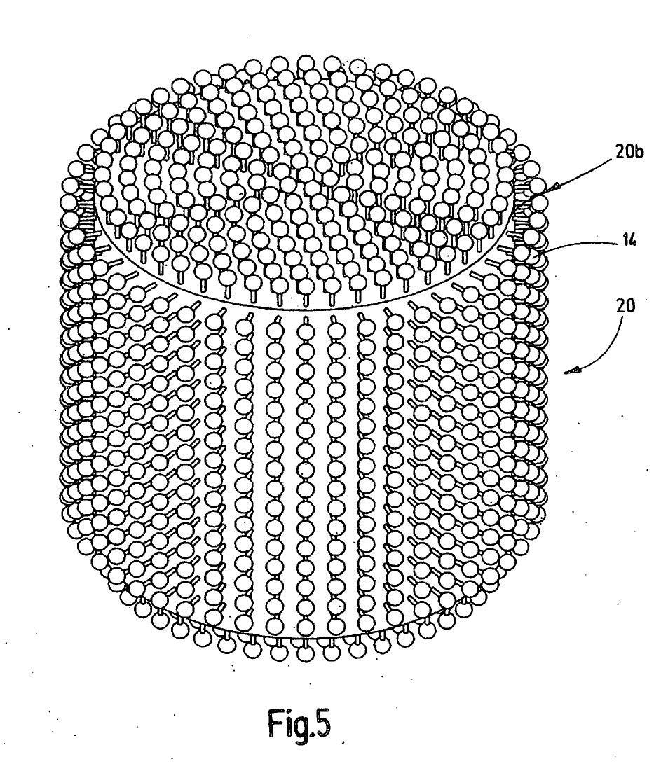

Finally, FIG. 5 shows an embodiment analogous to FIG. 4, but in this case the adhesive particle 20b is cylindrical in shape.

The invention is further described by means of two examples below.

### EXAMPLE 1

### Adhesive Bandage Based on an Elastic Gauze Bandage Woven Fabric for Fixation Purposes

As the substrate textile (substrate 30) for an inventive adhesive bandage, an elastic gauze bandage woven fabric with a defined width, e.g. 8 cm, according to DIN 61634 having the following structure was used:

| | |
|---|---|
| Material structure woven | 71% viscose, 29% polyamide, |
| | plain weave |
| Warp thread 1/warp thread 2 | 17 tex viscose/78dtex f 17 x 2 |
| | polyamide textured |
| Thread counts | 56/56 per 10 cm width |
| Warp thread 1/warp thread 2 | |
| Weft thread | 17 tex viscose staple fiber yarn |
| Weft thread density | 36 double weft per 10 cm when |
| | stretched |
| | (DIN 61632) |
| Weight per unit area when | 32 g/m² (DIN 61632) |
| stretched | |
| Elasticity | In longitudinal direction (warp |
| | direction) |
| Extensibility/recovery | 140%/99% (DIN 61632) |
| Permeability to air | 6000 l/m² sec (DIN 53887) |

The inventive adhesive bandage was manufactured using the commercially available hook-and-loop fastener polymer foil known by the commercial name of MICROPLAST 65445 from G. Binder GmbH & Co., Holzgerlingen, Germany, as the adhesive element 10a, which contains the means of adhesion 14 in the form of stems with mushroom heads on the surface. The technical data of this adhesive element foil are provided below:

| | |
|---|---|
| Material | Polypropylene extruded, |
| | transparent |
| Weight per unit area | 135 g/m² |
| Thickness total | 360 μm |
| Structure | Means of adhesion one side, |
| | reverse side smooth |
| Means of adhesion | Stems with mushroom head |
| | hexagonal, |
| | height 250 μm |
| Adhesive density | 288 items per cm² |
| per unit area | |
| Configuration | Regular distribution (chess-board |
| | pattern) |

The foil is fed in the form of a roll of defined width, e.g. 40 cm, into a squeeze-cutter device and cut into strips of width 3 mm that are then cut, punched, or otherwise divided by a suitable method transversely into 15-mm long cut pieces. Each foil cut piece 12 obtained by cutting in this way has a rectangular surface of 0.45 cm². The cut pieces are laminated in a regularly recurring pattern of a sort of orthogonal grid pattern (see FIG. 6) onto a strip of the substrate 30 on one side as follows:

The cut pieces are coated on their smooth reverse side with a quantity sufficient for permanent attachment to the substrate 30 of a pressure-sensitive bonding agent (e.g. acrylate dispersion glue, hot-melt glue, solvent-based rubber glue, such as PATTEX, Henkel KGaA, Germany) by spraying, immersion, doctoring, spreading, etc. and then disposed on the surface of the substrate 30, which is laid down without tension, according to the pattern in FIG. 6, view a) in such a way that the centers of gravity of the cut pieces are at intervals of 3 cm or they form a regular grid with a 3-cm pitch. After pressing on and drying or cooling of the glued joints, the cut pieces are firmly attached to the substrate 30 by their reverse sides and the means of adhesion 14 (mushroom heads) point outward. In the non-stretched condition of the planar structure 40, the proportion by area that the foil cut pieces make up of the substrate 30 is approx. 7.5%; in the stretched condition, it is approx. 3%. The stretched condition after stretching in the direction of the arrow is shown in FIG. 6, view b).

The textile strip manufactured in this way has, over its entire length, an adhesive surface with partial and discrete coating with adhesive elements. The density per unit area of the adhesive elements 10a on the one side of the textile substrate is 1.1-10³ items per square meter in the non-stretched condition.

When the adhesive side is pressed onto itself and onto the uncoated reverse side, adhesion occurs between the layers according to the hook-and-loop principle, with the mushroom heads of the adhesive cut foil pieces hooking with the individual fibers or filaments of the warp and weft threads of the textile substrate 30. A defined force is necessary to separate the layers. If the “peel test method (peel strength)” according to DIN EN 12242-1999 is used, the resulting adhesive force is 10 cN/cm, i.e. 100 cN are necessary to separate the layers in the case of a 10-cm wide bandage.

The textile tape manufactured in this way with a one-sided adhesive surface has the following properties:

Weight per unit area when stretched: 33.5 g/m²

### Extensibility DIN 61632: 120%

### Recovery DIN 61632: 98%

Permeability to air DIN 53887: 5600 l/m² sec

Before application, the textile tape is wound in the mostly tensionless (non-stretched) condition in an analogous way to commercially available fixation bandages to form a wound bandage in the shape of a roll. In this case, the side with the adhesive elements is disposed on the outside or inside, preferably the outside, of the wound bandage. In the latter case, the adhesive elements are located on the skin side while the outside of the bandage is the reverse side of the base textile. The adhesive bandage according to Example 1 can, for example, be used for fixing a wound compress in the region of the wound on an injured part of the body. For this purpose, the wound compress is applied to the wound and then wound round the injured part of the body including the wound compress by unrolling the adhesive bandage with slight tension, wherein the adhesive elements may also hook with the bandage surface and, if applicable, with the reverse side of the wound compress. This results in an adhesive, non-slip fixation bandage that holds the wound compress in the desired position.

### EXAMPLE 2

### Adhesive Bandage on an Elastic Nonwoven Base as a Supporting/Compression Bandage

An elastic nonwoven structure was used as the base textile (substrate 30) for an inventive adhesive bandage and was obtained by cover-seaming with a rigid polyester nonwoven with permanently elastic spandex threads in the longitudinal direction using the MALIWATT stitch-bonded knit method. For details of this substrate textile, see the table below:

| | |
|---|---|
| Material structure | 80% polyester |
| Elastic nonwoven | 20% polyurethane - spandex |
| Base - nonwoven | PES staple fiber nonwoven, 25 |
| | g/m², thermally bonded, embossed |
| Sewing thread | 133 dtex spandex (DORASTAN, |
| | BAYER) |
| Sewing thread density | 45 threads per 10 cm width |
| Sewing thread - stitch length, | 3 mm, open fringe |
| binding | |
| Weight per unit area when | 32 g/m² |
| stretched | |
| Elasticity | In longitudinal direction (warp |
| | direction) |
| Extensibility/recovery per DIN | 250%/99% |
| 61623 | |
| Nonwoven width | 100 cm |
| Permeability to air DIN 53887 | 2000 l/m² sec when not stretched |

To manufacture the inventive adhesive bandage, the commercially available hook-and-loop fastener polymer foil known by the commercial name of MICROPLAST 65445 from G. Binder GmbH & Co., Holzgerlingen, Germany, was used as the adhesive element 10a, which contains the means of adhesion 14 in the form of stems with mushroom heads on the surface. The technical data of this adhesive element foil are provided below:

| | |
|---|---|
| Material | Polypropylene extruded, |
| | transparent |
| Weight per unit area | 135 g/m² |
| Thickness total | 360 μm |
| Structure | Means of adhesion one side, |
| | reverse side smooth |
| Means of adhesion | Stems with mushroom head |
| | hexagonal, |
| | height 250 μm |
| Density per unit area of the means | 288 items per cm² |
| of adhesion | |
| Configuration | Regular distribution (chess-board |
| | pattern) |

The foil is fed in the form of a roll of width 100 cm into a squeeze-cutter device and cut in the transverse transfer direction into strips of width 3 mm, which are then applied using a gripper device at 50-mm intervals in a repeating pattern with the smooth side on the surface of the fed non-woven web. Each foil cut piece obtained by cutting in this way has a rectangular surface of 30 cm². By spot or full-surface welding using multiple ultrasound welding heads (manufacturer: SONOTRONIC, Karlsbad), the cut pieces are thermally joined to the substrate 30 over the entire width by the friction heat produced by pressing on the sonotrodes. In this case, the smooth side of the adhesive elements is permanently joined to the textile surface of the substrate. The means of adhesion 14 (mushroom heads) face outward. In the non-stretched condition, the proportion by area that the adhesive foil cut pieces make up of the textile base of the substrate 30 is approx. 6%; in the stretched condition, it is approx. 1.7%.

The broad run of textile produced in this way is cut using cutters (preferably hot cutting or ultrasound cutting) into bandage strips of a defined width, e.g. 6, 8, 10, 12 cm, which, like the broad run of textile, have an adhesive surface with partial coating with means of adhesion over the entire length. The density per unit area of the adhesive elements on one side of the textile substrate 30 is 2·10² items per square meter for the 10-cm bandage width in the non-stretched condition and 3.3·10² items per square meter for the 6-cm bandage width.

When the adhesive side is pressed onto itself and onto the uncoated reverse side, adhesion occurs between the layers according to the hook-and-loop principle, with the mushroom heads of the adhesive foil cut pieces hooking with the individual fibers or filaments of the nonwoven. A defined force is necessary to separate the layers. If the “peel test method (peel strength)” according to DIN EN 12242-1999 is used, the resulting adhesive force is 35 cN/cm, i.e. 350 cN are necessary to separate the layers in the case of a 10-cm wide bandage. This provides a sufficiently secure and reliable connection between the layers in the complete bandage.

The planar structure 40 manufactured in this way with a one-sided adhesive surface has the following properties:

Weight per unit area when stretched: 40 g/m²

### Extensibility DIN 61632: 230%

### Recovery DIN 61632: 99%

Permeability to air DIN 53887: 1800 l/m² sec

For application, the planar structure 40 is wound in the non-tensioned condition, with the adhesive elements 10a facing either outward or inward.

In an analogous way, the nonwoven can also be laminated on the front and reverse side, i.e. on both sides, with strip-like cut pieces of the adhesive foil. In the non-stretched condition, the proportion by area that the adhesive foil cut pieces make up of the textile base of the substrate is then approx. 12%; in the stretched condition, it is approx. 3.5%. The weight per unit area increases to approx. 48 g/m². Further layers of bandage can be adhesively fixed on a bandage made of this substrate with adhesive elements disposed on both sides, since those layers enter into a connection with the adhesive elements. An adhesive bandage according to Example 2 can be used, for example, for compression treatment of vein disorders of the leg. For this purpose, the adhesive bandage is unrolled with a slight, constant tension and wound around the entire lower leg of the patient on the ailing leg, starting at the metatarsophalangeal articulations, in a defined number of layers, e.g. three layers. The adhesive elements hook with the reverse-side bandage surface, resulting in an adhesive, non-slip compression bandage that is worn for several days as part of decongestive or compression therapy. During winding, bandages, e.g. gauze bandages, padding bandages can be fixed to the adhesive elements further disposed on the outside.

1-15. (canceled)

16. A medical adhesive planar structure comprising:
a textile substrate having a first side and a second side opposite said first side, said textile substrate comprising a first warp thread group consisting essentially of elastic threads and at least one second warp thread group consisting essentially of non-elastic threads;
a first mechanical adhesive structure applied to said first side of said substrate, said first mechanical adhesive structure composed of a multiplicity of discrete first adhesive elements; and
a second adhesive structure disposed on said second side of the substrate, wherein said first and said second adhesive structures can be brought into adhesive connection with each other, the medical adhesive structure having an elastic extensibility of between 40% and 300%.

17. The medical planar structure of claim 16, wherein the planar structure exerts an adhesive force of 5 to 120 cN/cm and a proportion by area that said first adhesive structure occupies on said first side of a non-stretched said textile substrate is in a range of 1 to 50% of an area of said first side.

18. The medical planar structure of claim 16, wherein the planar structure exerts an adhesive force of 5 to 120 cN/cm and said first adhesive elements are separately distributed on a non-stretched planar structure with a density per unit area of 10² to 10⁶ items per square meter.

19. The medical planar structure of claim 16, wherein the planar structure exerts an adhesive force of 5 to 120 cN/cm and said first adhesive elements are separately distributed on a non-stretched planar structure with a density per unit area of 10² to 10⁶ items per square meter, wherein a proportion by area that said first adhesive structure occupies on said first side of a non-stretched textile substrate is in a range of 1 to 50% of an area of said first side.

20. The medical planar structure of claim 16, wherein said substrate comprises one or more weft threads.

21. The medical planar structure of claim 16, wherein said substrate comprises a nonwoven.

22. The medical planar of claim 16, wherein the planar structure has a length L and a width B, wherein the planar structure is homogeneously elastically extensible over an entire said length L.

23. The medical planar structure of claim 16, wherein said first adhesive elements are constituted by planar geometric bodies with a height-to-length ratio of 1 to 10⁻³ or by adhesive particles with a height-to-length ratio of 1 to 10⁻¹, wherein means of adhesion are disposed on said adhesive elements.

24. The medical planar structure of claim 16, wherein said means of adhesion have a shape of a stem or hook.

25. The medical planar structure of claim 16, wherein said second adhesive structure is constituted by said substrate.

26. The medical planar structure of claim 16, wherein said textile substrate is a woven, knitted fabric, stitch-bonded knitted or stitch-bonded nonwoven.

27. The medical planar structure of claim 16, wherein the planar structure has a weight per unit area of at least 10 g/m² and no more than 350 g/m².

28. The medical planar structure of claim 16, wherein the planar structure is structured and dimensioned as an elastic compression bandage, an elastic fixation bandage, or an elastic supporting bandage.

29. A method for the manufacture of the medical adhesive planar structure of claim 16, wherein, in a first step, said adhesive elements fitted with means of adhesion are manufactured by isolation of polymer foils in a form of cut pieces of length L, width B, and height H and, in a second step, the cut pieces are disposed on a surface of the textile substrate in discrete distribution and firmly connected with the substrate by sewing, bonding, welding or pressing.

30. A method for the manufacture of the medical adhesive planar structure of claim 16, wherein adhesive particles provided with means of adhesion are manufactured directly by extrusion with a defined length L, width B, and height H and then disposed on a surface of the textile substrate in discrete distribution and firmly connected with the substrate by sewing, bonding, welding or pressing.
